(19) United States
(12) Patent Application Publication
(10) Pub. No.: US 2023/0037036 A1
(43) Pub. Date: Feb. 2, 2023

(54) CONNECTION POINT FOR AN INSTALLATION, AND INSTALLATION FOR PRODUCING THREE-DIMENSIONAL COMPONENTS

(71) Applicant: One Click Metal GmbH, Tamm (DE)

(72) Inventors: Roman DENISOV, Ludwigsburg (DE); Björn ULLMANN, Bönnigheim (DE)

(21) Appl. No.: 17/814,922

(22) Filed: Jul. 26, 2022

(30) Foreign Application Priority Data
Jul. 26, 2021 (DE) 10 2021 119 307.9

(51) Int. Cl. B22F 12/58; B22F 12/41; B22F 10/28; B33Y 30/00

(52) U.S. Cl. CPC B22F 12/58; B22F 12/41; B22F 10/28; B33Y 30/00

(57) ABSTRACT

A connection point for a feeding station and/or an emptying station for powdered building material of a building station, unpacking station and/or sieve station which can be combined to form an installation for producing three-dimensional components by layer-by-layer solidification by means of a beam acting on the powdered building material, having a docking port which has a free connection side, having a closure member which opens and closes a passage in the docking port, having a connection port of a connecting device, which connection port can be connected to the docking port and, opposite the connection port, receives a cartridge container, having a closure member which is provided on the connection port and opens and closes a passage of the connection port, wherein, after the connection port has been connected to the docking port, the closure member in the connection port and the closure member in the docking port form a lock for the powdered building material in the feeding station for feeding and in the emptying station for discharging powdered building material.

The invention relates to a connection point of a feeding station and/or of an emptying station for powdered building material in a building station, unpacking station and/or sieve station which can be connected together to form an installation for producing three-dimensional components by selective solidification by means of a beam acting on a powdered building material. The invention relates further to an installation for producing a three-dimensional component by selective solidification by means of a beam acting on a powdered building material, which installation comprises at least one such connection point in a building station, unpacking station and/or sieve station.

An installation for producing three-dimensional components by successively solidifying layers of the powdered building material is known from DE 10 2019 130 951 A1. For supplying the installation with powdered building material and also for emptying the installation of powdered building material, cartridges which can be positioned in cartridge slots are known. Such a cartridge comprises a container in which the powdered building material is stored or which can be filled with the powdered building material. An opening of the container is fixedly connected to a cartridge closure member. The cartridge closure member comprises a closure flap which can be activated for opening and closing via a connection element. After the cartridge has been inserted into a connection point, the closure flap is opened. If the container of the cartridge is filled with powdered building material, it is emptied. If the container of the cartridge is empty, cleaned or processed building material can be transferred into the container.

In interfaces in the building station, the unpacking station and the sieve station at which the above-described cartridge is fastened and removed again, there can be a risk of contamination with powdered building material.

The object underlying the invention is to propose a connection point of a feeding station and/or of an emptying station for powdered building material and also an installation for producing three-dimensional components having a building station, unpacking station and/or connection station, by means of which the risk of contamination of the surrounding area with powdered building material during changing of the cartridge containers is reduced.

This object is achieved by a connection point of a feeding station and/or emptying station for powdered building material which comprises a docking port which has a free connection side and comprises a closure member which opens and closes a passage in the docking port, wherein a connection port of a connecting device can be connected to the docking port and the connecting device receives a cartridge container opposite the connection port, wherein the connection port has a closure member which opens and closes a passage of the connection port and, after the connection port has been connected to the docking port, the closure member in the connection port and the closure member in the docking port form a lock for the powdered building material from the cartridge container to the feeding station and from the discharge station into the cartridge container. By means of this lock, different pressure conditions in the cartridge container on the one hand and in the feeding station or emptying station on the other hand can be equalized before the powdered building material is exchanged. Turbulence of the powdered building material can thus be avoided. The adhesion of powdered building material at the interface between the docking port and the connection port is also prevented.

The closure member of the connection port of the connecting device and the closure member of the docking port in the feeding station or emptying station are preferably closed in a starting position. On the one hand this has the advantage that the connecting device with the cartridge container fastened thereto can be handled safely. On the other hand, it is ensured that access via the feed device to a chamber of the building station, unpacking station and/or sieve station is closed. Furthermore, when the closure member in the docking port of the emptying station is closed, it can be ensured that powdered material does not unintentionally flow out as a result of vibrations.

Furthermore, the closure member is preferably in the form of a closure flap arranged in the passage. This permits a simple and constructive form and also activation for opening and closing of the passage.

Advantageously, the closure flap can be activated outside the housing of the connecting device by means of a drive which can be positioned on a driver member which actuates the pivot pin. This connecting device can thus be used for automatic emptying or filling of the cartridge container.

Furthermore, the pivot pin of the closure flap is preferably mounted in the housing and the pivot pin is sealed facing the passage by at least one seal. Powdered building material can thus be prevented from escaping to the outside via the pivot pin leading outside the housing.

The passage in the connecting device is preferably formed in the region of the opening by a connection port. This connection port permits simple positioning at the connection point of the components in the installation, such as, for example, positioning of the connecting device at a station or at an emptying station.

At the front end of the connection port there is preferably provided an internal insertion slope which merges into the passage in the connection port, which is preferably of cylindrical form. Simple positioning of the connection port on a docking port of an emptying station can thus be provided, for example, in that the connection port engages externally around the docking port.

Furthermore, the connection port is preferably surrounded by a free—preferably U-shaped—annular space which is configured to be open to the connection side of the housing of the connecting device. A docking port of a feeding station, for example, which engages the outer circumference of the connection port can thus be fitted to the connection port. This has the advantage that the powdered building material is able to fall or be transferred freely through the passage and the opening of the connection port into the docking port without powdered building material accumulating in the connection region.

Furthermore, at least one seal surrounding the connection port is preferably provided on the outer circumference of the connection port and facing into the annular space. Simple positioning of the connecting device with the connection port at a docking port of the feeding station or emptying station can thus be made possible, and at the same time a sealing interface can be created.

At least two seals which are spaced apart from one another are provided on the outer circumference of the connection port. The seal that is provided close to the end face of the connection port is preferably in the form of a powder scraper. The seal located behind it is preferably in the form of a gas sealing.

Furthermore, the docking port in the feeding station is preferably configured to be larger in circumference than the connection port of the connecting device, so that the connection port in a connection position of the connecting device in the feeding station engages into the docking port. In the feeding station, filled cartridge containers are used. Owing to the engagement of the docking port externally around the connection port, the powdered building material is able to flow freely downwards without powdered building material accumulating at the interface. As a result of this arrangement, no dead spaces are formed in the feed direction of the building material.

Furthermore, the docking port in the emptying station is preferably configured to be smaller in circumference than the docking port in the connecting device, so that the connection port in a connection position of the connecting device in the emptying station engages externally around the docking port. An arrangement that is free of interfering contours is thus created, so that the powdered building material to be guided out of the emptying station during transfer into the empty cartridge container can be transferred to the cartridge container without adhering to the interface between the connection port and the docking port.

According to an advantageous embodiment of the invention, the lock formed after the connecting device has been positioned at the feeding station can be activated to open in two successive steps, wherein the closure member in the docking station of the feed device opens before the closure member in the connection port of the connecting device. Any excess pressure that develops between the two closure members is thus dissipated into the further component connected to the feeding station, such as, for example, the powder storage funnel. The closure member in the docking port can thus be opened without an excess pressure acting on the cartridge container from the feeding station side.

Furthermore, it is preferably provided that, after the cartridge container has been emptied at the feeding station, the lock closes in the reverse order to which the lock opened at the feeding station.

Furthermore, the lock formed after the connecting device has been positioned at the emptying station can preferably be activated to open in two successive steps, wherein the closure member in the connection port of the connecting device opens before the closure member of the docking port of the emptying station. Any excess pressure in the lock between the two closure members is thus dissipated into the cartridge container before emptying of the building station, unpacking station or sieve station by filling of the cartridge container is subsequently carried out.

In particular, after the cartridge container has been filled in the connection point of the emptying station, the closure members are closed again in the reverse order to which they opened.

The object underlying the invention relates further to an installation, in particular for producing a three-dimensional component by selective solidification by means of a beam acting on a powdered building material, which installation consists at least of:
a building station which comprises a process chamber in which the component can be produced layer by layer on a substrate plate in a building module by selectively solidifying the building material, and having a feeding station arranged upstream of the process chamber in a powder circuit of the building station for feeding fresh or cleaned building material, and an emptying station arranged downstream of the process chamber for discharging processed building material, and/or
an unpacking station which comprises an unpacking chamber in which the component can be removed from the building module, and having an emptying station arranged downstream of the unpacking station in the powder circuit of the unpacking station for discharging processed building material, and/or
a sieve station which comprises a sieve device for separating oversized particles and/or impurities from processed building material, and having a feeding station arranged upstream of the sieve station in a powder circuit of the sieve station for receiving processed building material, and an emptying station arranged downstream of the sieve device for discharging cleaned building material,
wherein the feeding station and/or the emptying station each comprises a connection point according to one of the above-described embodiments.

In particular, the feeding station and/or emptying station comprises a docking port and a closure member which opens and closes a passage of the docking port. The connecting device has a connection port which can be connected to the docking port. Opposite the connection port, the connecting device receives a cartridge container. A lock is formed by the closure member on the connection port of the connecting device and the closure member of the docking port of the feeding station or the emptying station. Both the feed of powdered building material—that is to say the emptying of a cartridge container—and the discharge of powdered building material into the cartridge container—that is to say the emptying of powdered building material via the emptying station—can thus take place without pressure, whereby contamination of the surrounding area of the powdered building material is reduced.

The invention and further advantageous embodiments and further developments thereof will be described and explained in detail in the following text by means of the examples shown in the drawings. The features which are to be found in the description and the drawings can be applied according to the invention individually on their own or in a plurality in any desired combination. In the figures:

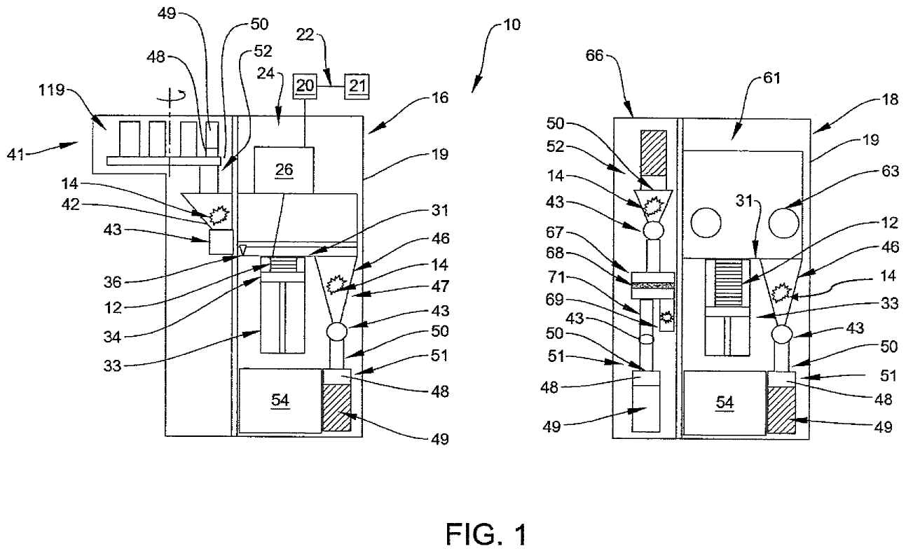

FIG. 1 is a schematic view from the front of an installation for producing three-dimensional components having a building station, an unpacking station and a sieve station,

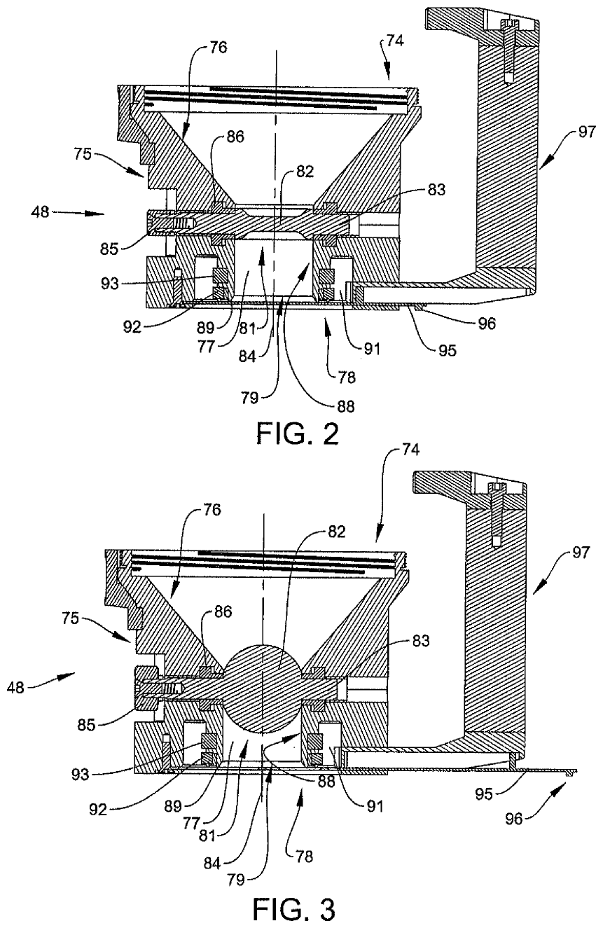

FIG. 2 is a schematic sectional view of a connecting device for receiving a cartridge container and for positioning in the installation according to FIG. 1,

FIG. 3 is a schematic sectional view of the connecting device according to FIG. 2 with an open closure member,

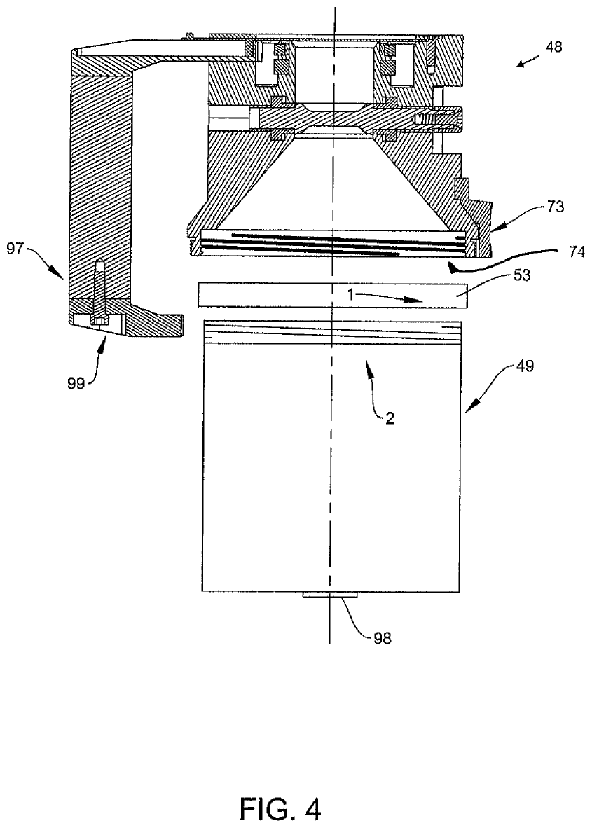

FIG. 4 is a schematic side view of the connecting device according to FIG. 2 for equipping with a cartridge container,

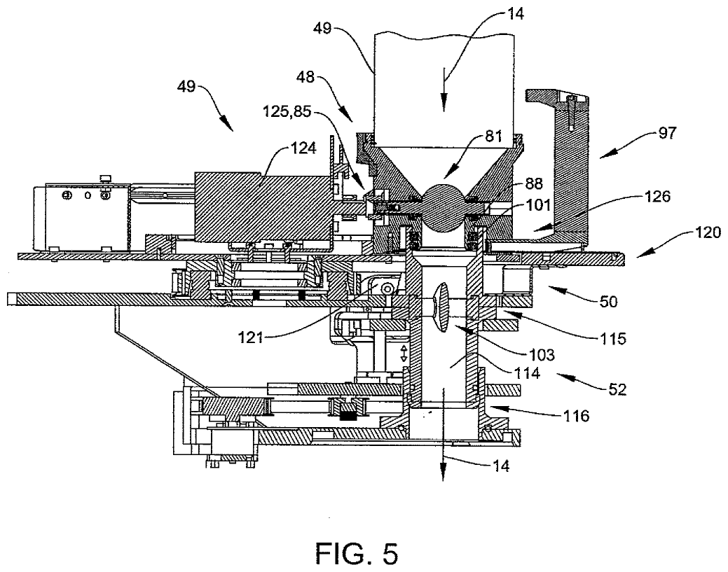

FIG. 5 is a schematic sectional view of the connecting device in conjunction with a feeding station, and

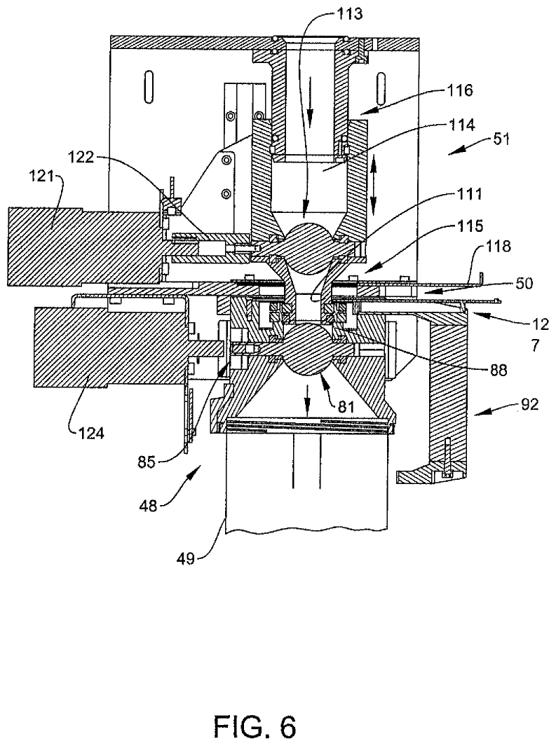

FIG. 6 is a schematic sectional view of the connecting device in conjunction with an emptying station.

FIG. 1 shows, schematically, a side view of an installation 10 for producing a three-dimensional component 12 by successively solidifying layers of a powdered building material 14. This installation 10 comprises, for example, a building station 16 and an unpacking station 18. This building station 16 and the unpacking station 18 each comprise a housing 19 and are provided separately from one another. Alternatively, this building station 16 and the unpacking station 18 can also be provided in a common housing 19 of the installation 10.

The building station 16 comprises a beam source 21, for example in the form of a laser source. This beam source 21 emits a beam 22, in particular a laser beam 22, which is fed via a beam guide to a processing head 26 of a process chamber 24. The beam 22 is directed via the processing head 26 onto the building material 14. This processing head 26 can be arranged on a linear axis system. This linear axis system 28 can be in the form of a two-axis system, so that the processing head 26 is movable in the process chamber 24 in the X-/Y-plane parallel to and above a work surface 31. Alternatively to the processing head 26, a scanner device can also be associated with the process chamber. The scanner device comprises a controllable scanner mirror by means of which the beam 21 is directed onto the building material 14.

In the work surface 31 there is a building module 33 within which a substrate plate 34 is guided so as to be movable up and down. The three-dimensional component 12 is produced on this substrate plate 34 by selectively solidifying the powdered building material 14.

Above the work surface 31 there is preferably provided an application and levelling device 36. This application and levelling device 36 travels over the work surface 31. In this manner, on the one hand the powdered building material 14 can be applied into the building module 33 and at the same time the excess building material 14 which has been applied can be discharged from the building module 33 in a collecting device 46 by the levelling device.

The building material 14 preferably consists of a metal powder or ceramics powder. Other materials which are suitable and employed for laser melting and/or laser sintering can also be used. The process chamber 24 is preferably hermetically sealed. For producing the three-dimensional component 12, the process chamber is filled with protecting gas or an inert gas in order to avoid oxidation on melting of the building material 14.

The building station 16 further comprises a powder storage device 41. This powder storage device 41 has a powder storage funnel 42 which is preferably equipped with a fill level sensor in order to detect the stored level of building material 14. Via a metering device 43, a predetermined amount of building material 14 is removed from the powder storage funnel 42 and fed to the application and levelling device 36 in the process chamber 24.

The building material 14 that has not solidified after the exposure process is transferred by means of the application and levelling device 36 into a collecting device 46. This collecting device 46 preferably comprises a collecting funnel 47, the opening of which is integrated in the work surface 31 or lies in the work surface 31. This collecting device 46 feeds the processed building material 14 introduced via the application and levelling device 36 to a downstream metering device 43.

Associated with this metering device 43 downstream is a connection point 50 of an emptying station 51, which is provided for connection of a connecting device 48 to which a cartridge container 49 can be fastened. This connecting device 48 will be described hereinbelow in FIGS. 2 and 3. Via the metering device 43, a predetermined amount of processed building material 14 is transferred into the cartridge container 49.

A storage place 54 for further cartridge containers 49 and/or connecting devices 48 can be provided in the housing 19 of the building station 16. Both filled and empty cartridge containers 49 can be stored in this storage place 54.

“Fresh building material” 14 is understood as being building material 14 that is for the first time provided for the production of a three-dimensional component 12 and fed to the process chamber 24 for the process of producing the three-dimensional component 12.

“Processed building material” 14 is understood as being powdered building material 14 that has been fed to the process chamber 24 and was not solidified by the selective solidification by means of the beam 22. This unsolidified powdered building material 14 is guided out of the process chamber 24 by the application and levelling device 36.

“Cleaned building material” 14 is understood as being building material 14 that, starting from processed building material, has been cleaned, for example in a sieve station. The processed building material is thereby freed of oversized impurities and the like. This cleaned building material can again be fed to the building station 16 for a work process.

The building station 16 can further comprise in the powder storage device 41 a connection point 50 of a feeding station 52 for at least one connecting device 48 with the cartridge container 49. This is shown herein below in FIG. 5.

The unpacking station 18 comprises an unpacking chamber 61 in which the building module 33, which for removal from the process chamber 24 is preferably closed by a cover, can be inserted in order subsequently to be emptied in the unpacking station 18. The substrate plate 34 with the component 12 is removed from the building module 33 and cleaned of unsolidified building material 14 in the unpacking chamber 61. The processed building material 14 which accumulates in the unpacking chamber 61 on a work surface 31 is transferred to a collecting device 46, which can be configured analogously to the collecting device 46 of the building station 16. Via the metering device 43, processed building material 14 is fed to the connection point 50 of the emptying station 51. A connecting device 48 which receives an empty cartridge container 49 can be fastened to the connection point 50. This cartridge container 49 is filled with processed building material 14.

Openings 63 with a glove port can be provided in the unpacking chamber 61 for freeing the component 12 of loose building material 14 and feeding the loose building material to the collecting device 46. A suction device for cleaning the component 12 and/or the work surface 31 can also be provided.

The cartridge container 49 filled with the processed building material 14 is fed to a sieve station 66. This sieve station 66 can be integrated in the unpacking station 18. The sieve station 66 can also be integrated in the building station 16. The sieve station 66 can further be arranged so that it is isolated and separate from the building station 16 and the unpacking station 18. The building station 16, the unpacking station 18 and the sieve station 66 can also form a common installation in a housing 19.

The sieve station 66 comprises at least one connection point 50 for receiving the connecting device 50 at a feeding station 52, to which the connecting device 48 with the cartridge container 49 can be fastened. The processed building material 14 delivered by the cartridge container 49 through connecting device 50 is preferably fed by means of a metering device 43, in particular a metering screw, to a sieve device 67. This sieve device 67 comprises a sieve 68 which can preferably be excited by means of ultrasonic frequencies or low frequencies. The processed powdered building material 14 can thereby be cleaned. For example, coarse particles or oversized particles and/or impurities can be retained by the sieve 68 and transferred to an oversized-particle container 69. The processed powdered building material 14, which is free of oversized particles and/or impurities, is discharged as cleaned building material 14 via an outlet opening 71. This further outlet opening 71 opens into a connection point 50 of an emptying station 51, to which the connecting device 48 with an empty cartridge container 49 arranged thereon can be fastened. The cartridge container 49 serves to receive the processed and cleaned powdered building material 14.

The connecting device 48 with the cartridge container 48 filled with the processed and cleaned building material 14 is then conveyed to the powder storage device 41 again in order to supply the powder storage device 41 with building material 14.

The term “feeding station” 52 is understood as meaning that the connecting device 48 with a cartridge container 49 filled with building material 14 can be connected to this feeding station 52 so that the building material 14 provided in the cartridge container 49 can be fed to the respective station, in particular the building station 16 and the sieve station 66.

The term “emptying station” 51 is understood as meaning that a connecting device 48 with an empty cartridge container 49 can be connected to this emptying station 51 in order to transfer processed and/or cleaned building material 14 into the cartridge container 49. The processed and/or cleaned building material 14 can thus be guided out of the respective station, in particular the building station 16, the unpacking station 18 and/or the sieve station 66.

FIG. 2 shows a schematic sectional view of the connecting device 48. This connecting device 48 comprises a cartridge receiver 74 to which the cartridge container 49 can be fastened. The cartridge receiver 74 preferably has a thread, so that the cartridge container 49 can be fastened by a screw connection. Alternatively, further plug and/or latching connections or the like can also be provided as the cartridge receiver 74. This cartridge receiver 74 is arranged at the face end of a housing 75 of the connecting device 48. Adjoining the cartridge receiver 74 is a funnel 76, which opens in a passage 77. This passage 77 has an opening 79 on the connection side 78 of the connecting device 48. The side that can be connected to the connection point 50 in the building station 16 and/or unpacking station 18 and/or sieve device 67 forms the connection side 78.

A closure member 81 is provided in the passage 77. This closure member 81 is shown in a closed position in FIG. 2. A connection between the cartridge receiver 74 and the connection side 78 is thus blocked. The closure member 81 is preferably in the form of a pivotable closure flap 82 which is mounted in the housing 75 so as to be rotatable about a pivot pin 83. This pivot pin 83 is preferably oriented at a right angle to the longitudinal axis 84 of the passage 77. Outside the housing 75 there is provided a driver member 85 which can be fastened to the pivot pin 83. By means of this driver member 85, an opening and closing operation of the closure member 81 can be activated by means of a motor and a control device, for example. The pivot pin 83 is connected to the housing 75 in a sealing manner by at least one seal 86. An elastomer seal is preferably provided.

The passage 77, on the connection side 78, is part of a connection port 88. This connection port 88 has at its front end an internal insertion slope 89 which merges into the passage 77. The passage 77 is preferably in the form of a cylindrical hole with a constant cross section. Surrounding the connection port 88 externally, a free annular space 91 is provided in the housing 75. The annular space 91 is preferably U-shaped. This annular space 91 is oriented so as to be open to the connection side 78. At least one seal 92, 93 is provided on the outer circumference of the connection port 88 and facing into the annular space 91. Associated with the end face of the connection port 88, a powder scraper is preferably provided as the seal 92 and, with the seal 93 located behind it, is in the form of a gas sealing. On the connection side 78 of the housing 75 there is provided a housing cover 95 by which the connection port 88 can be closed. This housing cover 95 is preferably in the form of a slidable cover which covers both the annular space 91 and the connection port 88—that is to say on the connection side 78. The housing cover 95 can further be sealed with respect to the surrounding area by means of a seal for the building material, in particular a felt wiper. This seal can be provided facing the annular space 91 and/or facing outwards to the surrounding area.

A handgrip 97 is further provided in the housing 95 of the connecting device 48. This handgrip 97 is fastened so that it is oriented towards the connection side 78. The handgrip 97 is preferably oriented parallel to the longitudinal axis 84 of the passage 77. The slidable housing cover 95 is preferably received on an underside of the handgrip 97, and a driver element 96 can be provided on the housing cover 95 so that automatic opening and closing of the connecting device 48 is activatable.

FIG. 3 shows the connecting device 48 according to FIG. 2 in a sectional view, wherein the closure flap 82 is shown in an open position. Furthermore, the housing cover 95 is open. A passage between the cartridge receiver 74 and the connection port 88 is thus freed.

FIG. 4 shows, schematically, an arrangement for connecting the connecting device 48 to the cartridge container 49. A cover 53 of the cartridge container 49 is removed. In an upside-down arrangement, the connecting device 48 is positioned with the cartridge receiver 74 at the opening of the cartridge container 49. The cartridge container 49 is then connected to the connecting device 48. The closure member 81 and the housing cover 95 are in a closed position. If the cartridge container 49 is filled with building material 14, a marking 98 attached to the cartridge container 49 or the marking 98 attached to the cover can then be read out by means of an electrical device. This marking 98 can be in the form of a NFC/RFID tag (NFC—near field communication, RFID—radio frequency identification), which is preferably attached by adhesive bonding. A colored marking corresponding to the building material 14 provided can be fastened to a holder 99 on the handgrip 97. Alternatively, the marking 98 can be removed and fastened to the holder 99.

Furthermore, a further marking 73 can preferably be provided on an outer side of the cartridge receiver 74. This marking can be, for example, a RFID chip which is writable and/or readable. For example, this marking 73 can contain information as to whether a full or empty cartridge container 49 has been connected to the cartridge receiver 74, for example. Furthermore, information as to whether the cartridge container 49 contains fresh, processed or cleaned building material 14 can be stored. Further data can likewise be read in, so that the necessary information can be read out at every process step. For example, a comparison between the marking 98 and the further marking 73 can be carried out in order to determine whether there is a permissible combination of features or whether features match. It is thus possible to prevent a cartridge receiver 74 that in a preceding process was exposed to an aluminum powder, for example, and a cartridge container 49 that contains a building material 14 of noble metal, for example, from being connected together, since such a material mixture can lead to a risk of ignition.

By interrogation of the respective markings 73 and 98, an increase in the process reliability can be achieved.

By means of the marking 98, it is possible to ascertain at a later point in time what building material 14 is in the cartridge container 49. The connecting device 48 with the cartridge container 49 fastened thereto is then rotated through 180° and can then be inserted into a feeding station 52. The housing cover 95 is thereby opened first so that the connection port 88 is accessible for connection to the connection point 50.

In FIG. 5, the connecting device 48 with the cartridge container 49 fastened thereto is oriented towards the feeding station 52. The feeding station 52 can be connected to a powder storage funnel 42, for example. The feeding station 52 comprises a docking port 101. This docking port 101 can be moved up and down relative to a guide 116 of the feeding station 52. In a starting position, the docking port 101 is arranged in a lower position. The connecting device 48 can thus be oriented in a simple manner at the connection point 50 of the feeding station 52. For example, the connecting device 48 can be stored in a magazine 120. The magazine 120 can transfer the connecting device 48 with the filled cartridge container 49 into an emptying position 126 at the feeding station 52 by a sliding movement or a rotation.

Once the connecting device 48 has assumed the unloading position 126 at the docking port 101 in the feeding station 52, a displacement movement of the docking port 101 vertically upwards is activated, so that the docking port 101 is fitted to the connection port 88. The docking port 101 is configured to be larger in circumference than the connection port 88, so that the connection port 88 engages into the docking port 101. By means of the seals 92, 93 provided on the outer circumference of the connection port 88, automatic sealing with respect to the docking port 101 is thus created when the connection port 88 is inserted in the docking port 101.

The docking port 111 comprises a passage 114. This passage 114 can open into the powder storage funnel 42, for example. A closure member 103 is provided in the passage 114. This closure member 103 has a closure flap 82 which is analogous and/or corresponds to the closure member 81 of the connection port 88. This docking port 101 can also be part of the powder storage funnel 42. At the time of fitting of the connecting device 48 to the feeding station 52 or at the time of displacement of the connecting device 48 with the magazine 120 into the emptying position 126 at the feeding station 52, the closure member 103 in the docking port 101 is closed, as is the closure member 81 in the connecting device 48. After the connection port 81 has been connected to the docking port 101, a closed lock 115 is formed. This lock 115 is formed on the one hand by the closure member 81 in the connecting device 48 and on the other hand by the closure member 103 in the docking port 101 of the feeding station 52.

For transferring the building material 14 from the cartridge container 49 into the powder storage funnel 42, the closure member 103 is first opened. The closure member 103 can be rotatably activated by a motor 121 for opening. This motor 121 is connected via a coupling 122 to the pivot pin 83 of the closure member 103, as is apparent by way of example from FIG. 6. By opening the closure member 103, the air compressed between the two closure members 81, 103 can be discharged into the powder storage funnel 42. The closure member 81 in the connecting device 88 is then opened. For opening the closure member 81, a motor 124 is activated. On the motor 124 there is provided a gripping coupling 125, which is U-shaped. The driver member 85 of the closure member 81 of the connection port 88 is rectangular in form. In the closed position of the closure member 81, the long side of the driver member 83 is oriented horizontally, so that, when the magazine 120 is moved into the emptying position 126, the driver member 85 is introduced into the gripping coupling 125. Alternatively, a sliding movement can first be activated, so that a drive shaft of the motor 124 engages the driver member 85 of the pivot pin 83 of the closure member 81 in order to transfer the closure member from a closed position into an open position shown in FIG. 5.

As a result of the engagement of the connection port 88 into the docking port 101, an arrangement without undercuts—when seen in the direction of flow of the building material 14—is created between the cartridge container 49 and, for example, the powder storage funnel 42. The powdered building material 14 flows through the feeding station 52 independently, without resulting in an accumulation of building material.

After the cartridge container 49 has been emptied, first the closure member 103 in the docking port 101 and then the closure member 81 in the connecting device 48 is closed. The connecting device 48 is then removed and the housing cover 95 is closed. Alternatively, the magazine 120 can be advanced, so that the connecting device 48 with the emptied cartridge container 49 is transferred into a loading/unloading position 128.

FIG. 6 shows a schematic sectional view of the connecting device 48 with an empty cartridge container 49, which is associated with a connection point 50 of an emptying station 51, for example in the building station 16, the unpacking station 18 and/or the sieve station 66. The emptying station 51 has a docking port 111 with a passage 114. This passage 114 has a closure member 113, by means of which the passage 114 is opened and closed. This closure member 113 can comprise a closure flap 82, which can correspond to the closure flap 82 of the closure member 81 of the connection port 88. Preferably, the closure member 113 is configured analogously to the closure member 81 in respect of the pivot pin of the seal and the activation for opening and closing. The closure member 113 in the docking port 111 of the emptying station 51 is closed in a starting position. Before the connecting device 48 is connected to the connection point 50 of the emptying station 51, the closure member 81 of the connecting device 48 is closed.

The docking port 111 of the emptying station 51 can be moved up and down by a guide 116. In a starting position of the docking port 111, the docking port is arranged in an upper position and a housing cover 118 is preferably closed. In preparation for an emptying process, the housing cover 118, where present, is opened. The connecting device 48 is then positioned at the connection point 50 of the emptying station 51. This can also be carried out by advancing the connecting device 48 arranged in the magazine 120. The docking port 111 is then preferably brought to the connection port 88 and they are connected together.

There is thus formed a closed lock 115 and the closure member 113 in the docking port 111. The docking port 111 of the emptying station 51 is configured to be smaller in diameter than the connection port 88, so that this docking port 111 engages into the connection port 88. Advantageously there are provided on the outer circumference of the docking port 111, analogously to the connection port 88, a powder scraper as the seal 92 and a gas sealing as the seal 93.

For filling the cartridge container 49, first the closure member 81 of the connecting device 48 and then the closure member 113 of the docking port 111 is opened. For opening the closure member 81, the motor 124 is activated. For example, a displacement movement of the motor 124 towards the pivot pin 83 can take place, so that a drive shaft engages the driver member 85 with a coupling on the motor 124. Alternatively, the connection can take place as described in relation to FIG. 5 in the case of the feeding station 52. The opening and closing movement of the closure member 113 in the docking port 111 is activated via the motor 121, which is connected to the driver member 85 via a coupling 122, for example. In this embodiment it is provided that the motor 121 can be moved up and down together with the docking port 111. After the closure members 81, 113 have been opened, a predetermined amount of processed or cleaned building material 14 is delivered by the metering device 43. When seen in the direction of flow of the building material 14, an undercut-free arrangement can again be formed by the arrangement of the docking port 111 within the connection port 88, so that an accumulation of building material 14 in dead spaces is avoided.

After the cartridge container 49 has been filled with processed or cleaned building material 14, preferably first the closure member 113 in the docking port 111 of the emptying station 51 and then the closure member 81 in the connecting device 48 is closed. This order can also be reversed. The connecting device 48 is then removed from the connection point 50 and the housing cover 95 is closed again. Alternatively, the connecting device 48 with the filled cartridge container 49 can be transferred by the magazine 120 into the loading/unloading position 128. Preferably, the docking port 111 in the emptying station 51 can be moved upwards, so that this connection point 50 at least can be closed with a housing cover 51.

| | |
|---|---|
| 10. | Installation |
| 11. | |
| 12. | Component |
| 13. | |
| 14. | Building material |
| 15. | |
| 16. | Building station |
| 17. | |
| 18. | Unpacking station |
| 19. | Housing |
| 20. | Beam guide |
| 21. | Beam source |
| 22. | Beam |
| 23. | Beam deflection device |
| 24. | Process chamber |
| 25. | |
| 26. | Processing head |
| 27. | |
| 28. | |
| 29. | |
| 30. | |
| 31. | Work surface |
| 32. | |
| 33. | Building module |
| 34. | Substrate plate |
| 36. | Application and levelling device |
| 41. | Powder storage device |
| 42. | Powder storage funnel |
| 43. | Metering device |
| 44. | Metering screw |
| 46. | Collecting device |
| 47. | Collecting funnel |
| 48. | Connecting device |
| 49. | Cartridge container |
| 50. | Connection point |
| 51. | Emptying station |
| 52. | Feeding station |
| 53. | Cover |
| 54. | Storage place |
| 61. | Unpacking chamber |
| 63. | Openings |
| 66. | Sieve station |
| 67. | Sieve device |
| 68. | Sieve |
| 69. | Oversized-particle container |
| 71. | Outlet opening |
| 74. | Cartridge receiver |
| 75. | Housing |
| 76. | Funnel |
| 77. | Passage |
| 78. | Connection side |
| 81. | Closure member |
| 82. | Closure flap |
| 83. | Pivot pin |
| 84. | Longitudinal axis of 77 |
| 85. | Driver member |
| 86. | Sealing |
| 88. | Connection port |
| 89. | Insertion chamfer |
| 91. | Annular space |
| 92. | Seal |
| 93. | Seal |
| 95. | Housing cover |
| 96. | Driver element |
| 97. | Handgrip |
| 98. | Marking |
| 99. | Holder |
| 101. | Docking port |
| 103. | Closure member |
| 111. | Docking port |
| 113. | Closure member |
| 114. | Passage |
| 115. | Lock |
| 116. | Guide |
| 118. | Housing cover |
| 120. | Magazine |
| 121. | Motor |
| 122. | Coupling |
| 124. | Motor |
| 125. | Gripping coupling |
| 126. | Emptying position |
| 127. | Filling position |
| 128. | Loading/unloading position |

1. A connection point for a feeding station and/or an emptying station for powdered building material of a building station, unpacking station and/or sieve station which are combinable to form an installation for producing three-dimensional components by layer-by-layer solidification by means of a beam acting on the powdered building material,
having a docking port which has a free connection side,
having a closure member which opens and closes a passage in the docking port,
having a connection port of a connecting device, which connection port is connectable to the docking port and, opposite the connection port, receives a cartridge container,
having a closure member which is provided on the connection port and opens and closes a passage of the connection port,
wherein, after the connection port has been connected to the docking port, the closure member in the connection port and the closure member in the docking port form a lock for the powdered building material in the feeding station for feeding and in the emptying station for discharging powdered building material.

2. The connection point according to claim 1, wherein the closure member of the docking port and the closure member of the connection port of the connecting device are closed in a starting position.

3. The connection point according to claim 1, wherein the closure member is in the form of a closure flap arranged in the passage.

4. The connection point according to claim 3, wherein the closure flap is mounted in the housing so as to be rotatable about a pivot pin, and the pivot pin is preferably oriented perpendicular to the longitudinal axis of the passage.

5. The connection point according to claim 4, wherein the closure member has a pivot pin extending outside the housing and having a driver member which is preferably connectable to a drive.

6. The connection point according to claim 4, wherein the pivot pin of the closure flap is mounted in the housing and is sealed facing the passage by at least one seal.

7. The connection point according to claim 1, wherein a front end of the connection port has an internal insertion slope which merges into the passage in the connection port.

8. The connection point according to claim 1, wherein the connection port is surrounded by a free, annular space which is configured to be open to the connection point of the housing.

9. The connection point according to claim 8, wherein at least one seal surrounding the connection port is provided on the outer circumference of the connection port and facing into the free annular space.

10. The connection point according to claim 9, wherein at least two seals which are spaced apart from one another and are different from one another are provided on the connection port.

11. The connection point according to claim 9, wherein the seal that is provided close to the end face of the connection port is in the form of a powder scraper and the seal located behind it is in the form of a gas sealing.

12. The connection point according to claim 1, wherein the docking port in the feeding station is configured to be larger in circumference than the connection port of the connecting device, so that the connection port in a connection position at the feeding station engages into the docking port.

13. The connection point according to claim 1, wherein the docking port in the emptying station is configured to be smaller in circumference than the connection port of the connecting device, so that the connection port in a connection position relative to the emptying station engages externally around the docking port.

14. The connection point according to claim 1, wherein the lock formed after the connecting device has been positioned at the feeding station is activatable to open in two successive steps, wherein the closure member in the docking port of the feeding station opens before the closure member in the connection port of the connecting device.

15. The connection point according to claim 14, wherein, after the cartridge container has been emptied via the feeding station, the lock closes in the reverse order to which it opened.

16. The connection point according to claim 1, wherein the lock formed after the connecting device has been positioned at the emptying station is activatable to open in two successive steps, wherein the closure member in the connection port of the connecting device opens before the closure member of the docking port of the emptying station.

17. The connection point according to claim 16, wherein, after the cartridge container has been filled via the emptying station, the lock closes in the reverse order to which it opened.

18. An installation, in particular for producing a three-dimensional component by layer-by-layer solidification by means of a beam acting on a powdered building material, which installation consists at least of:
a building station which comprises a process chamber in which the component is producible layer by layer on a substrate plate in a building module by selectively solidifying the building material, and having a feeding station arranged upstream of the process chamber in a powder circuit of the building station for feeding fresh or cleaned building material, and having an emptying station arranged downstream of the process chamber for discharging processed building material, and/or
having an unpacking station which comprises an unpacking chamber in which the component is removable from the building module, and having an emptying station arranged downstream of the unpacking chamber in a powder circuit of the unpacking station for discharging processed building material, and/or
having a sieve station which comprises a sieve device for separating oversized particles and/or impurities from processed building material, and having a feeding station arranged upstream of the sieve device in a powder circuit of the sieve station for feeding processed building material, and an emptying station arranged downstream of the sieve device for discharging cleaned building material,
wherein
the feeding station and/or emptying station each has a connection point according to claim 1.
